(19) United States
(12) Patent Application Publication
(10) Pub. No.: US 2016/0288219 A1
(43) Pub. Date: Oct. 6, 2016

(54) DRILL HEAD

(71) Applicant: Marcelo H. Carrascosa, Houston, TX (US)

(72) Inventor: Marcelo H. Carrascosa, Houston, TX (US)

(21) Appl. No.: 14/678,508

(22) Filed: Apr. 3, 2015

(51) Int. Cl. B23B 51/04

(52) U.S. Cl. CPC B23B 51/0466; B23B 2205/04; B23B 2251/428; B23B 2251/50; B23B 2251/54; B23B 2251/56

(57) ABSTRACT

The present application regards examples of a drill head system including a self-centering cutting tool insert to include a cutting face. In an example, the drill head system may also include a drill head to cut a trepan hole, where the drill head includes an insert pocket to hold the self-centering cutting tool insert to the drill head without a cartridge disposed between the self-centering cutting tool insert and the drill head. In an example, the drill head system also includes a fastener securing the self-centering cutting tool insert into the insert pocket of the drill head through the cutting face.

### BACKGROUND

A material to be drilled may be cut by a drill head that is attached to the end of a drill bar. The drill head is to machine through material and may provide a hole in the material. Trepanning is a specific type of drilling for providing a hole along a circular path where an inner core of material remains after the trepanning process has been completed. Drill heads can be used to trepan in machining a large range of hole sizes, and may be highly economical for large diameter holes as trepan machining only removes the material along the circular path rather than all of the material within the hole. The inner core material may be more valuable in a single cut out piece rather than in shavings form. When a hole has been trepanned it may also be useful to separately bore the drilled diameter to provide a more accurately measured hole with a particular finish. The accuracy of a hole may be measured by tolerances. To reduce tolerances, many drills now adopt a multi-cutting tool style drill head that may cut and bore simultaneously.

### BRIEF DESCRIPTION OF THE DRAWINGS

Certain examples are described in the following detailed description and in reference to the drawings, in which:

FIG. 1 is a diagram of a drill head and self-centering cutting tool insert, according to an example;

FIG. 2 is a diagram of a side view of a drill head with a chip throat, according to an example;

FIG. 3 is a diagram of a side view of a drill head and self-centering cutting tool insert with screw threads, according to an example;

FIG. 4 is a top view of a drill head and a self-centering cutting tool insert, according to an example; and

FIG. 5 is a diagram of a top view of a drill head with multiple self-centering cutting tool inserts, according to an example.

### DETAILED DESCRIPTION OF SPECIFIC EXAMPLES

A drill head may be used in trepan drilling. The cutting or machining a drilling head does may be primarily accomplished by a cutting tool insert that is inserted into the drill head. The way the insert is positioned and attached to the drill head may result in a more precise result including a reduction of tolerances.

The present disclosure regards a drill head with a self-centering cutting tool insert. The drill head also may include an insert pocket to receive and aid the self-centering cutting tool insert to remain centered as the material to be machined is cut by the self-centering cutting tool insert. The drill head may include a dimensionally-toleranced insert, guide pads, with tighter tolerances applied to pad and insert locations. The drill head with the self-centering cutting tool insert is designed to reduce tolerances such that a drill head with a single cutting tool insert is to be within specified tolerances suitable for high precision industry operations. The reduction in the number of components in one example of the presently disclosed drill head may further reduce the cost of tool production and maintenance. In some examples, the drill head may include features such as 1 thread per inch or 2 threads per inch to aid in the ease in the removal and installation of the drill head to a drill bar. In other examples, the self-centering cutting tool insert may fasted to the drill head with a fastener to include a square drive screw to add holding strength to the self-centering cutting tool insert and to reduce screw breakage and stripping.

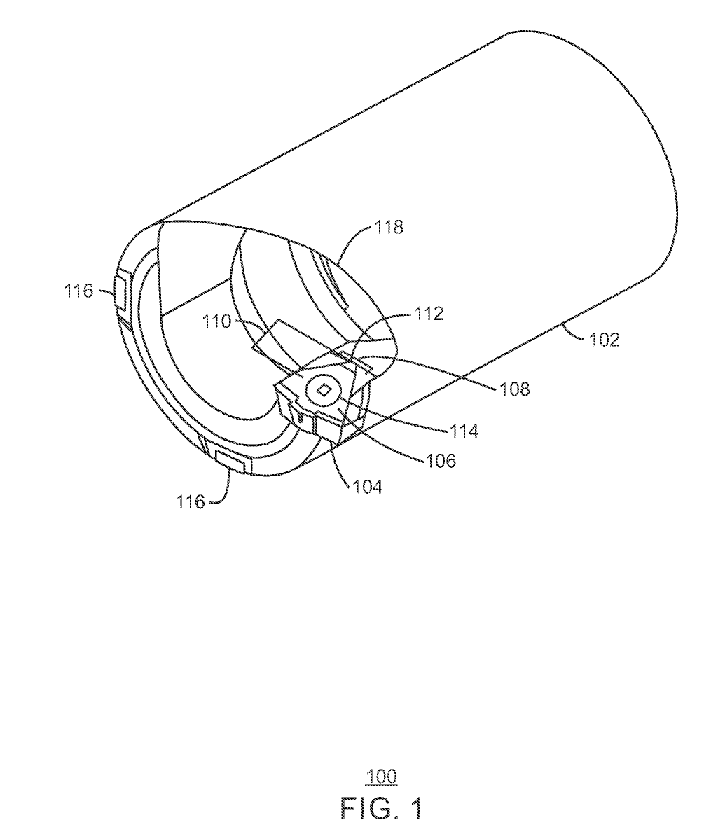

FIG. 1 is a diagram 100 of a drill head and self-centering cutting tool insert, according to an example. A drill head 102 may be used to machine a material including metals, plastics, ceramics, or any other malleable substance or substrate. The drill head 100 may itself be shaped to accommodate certain components to aid in drilling A self-centering cutting tool insert 104 may be included in the drill head. The self-centering cutting tool insert may be any suitable material for a machining process, however is often a carbide or other hard metal or suitable substance. The self-centering cutting tool insert 104 may include a cutting face 106 as one side of the self-centering cutting tool insert 104 that meets the material to be cut and may perform the actual cutting action on the material. This cutting action may be accomplished by the force of the material moving against the cutting face 106, the force of the cutting face 106 moving along the material, or any combination thereof.

The self-centering cutting tool insert 104 may be inserted in to an insert pocket 108 of the drilling head 102. In some examples, the insert pocket 108 is machined directly into the drill head 102. In some examples the exclusion of an intermediate cartridge to hold a cutting insert reduces the number of parts and the room for error or accumulation of tolerances. In some examples, the exclusion of an intermediate cartridge to connect the self-centering cutting tool insert 104 to the drill head 102 reduces set up time of the drilling system as well as the number of components to be purchased or maintained. In some examples, the self-centering cutting tool insert is the only cutting tool insert in the drill head 102. In some cases with only one cutting tool insert, less material is cut away and more of an inner diameter of a material may be saved and reused or resold. Further, with only one cutting tool insert, there is less material to cut and accordingly the torque to machine the material decreases, and with decreased torque comes decreased wear and tear corresponding to an extended life of a component part.

In some examples, the insert pocket 108 may be shaped to aid in centering the self-centering cutting tool insert 104 in a centered position on the drill head 104. In some examples this is accomplished through a matching taper or bevel of the self-centering cutting tool insert 104 and the pocket insert 108 of the drill head 102. The self-centering cutting tool insert 104 may include a lower region 110 that may be shaped to correspond to an insert pocket 108 to align the self-centering cutting tool insert 104 to a particular position for cutting. In some examples, the lower region 110 is shaped in a single narrowing taper resembling the letter “V” and the insert pocket 108 may be similarly shaped. The insertion of the self-centering cutting tool insert 104 with a V shape into a similarly shaped pocket insert 108 may not only guide the position, but may also decrease a wobble or clearance between the two pieces compared to a flat faced insert space in a drill head 102. A flat faced insertion space of a drill head 102 may result in wobbling of a cutting insert if any measurement or proportion of the insert is not exactly matched to an insert space. In contrast, in some examples, the presence of a sloped insert pocket 108 may guide a self-centering cutting tool insert 104 into a centered position even if the self-centering cutting tool insert 104 does not completely fill the area provided by the insert pocket 108. For example, as illustrated in the example shown in FIG. 1, the self-centering cutting tool 104 may leave empty space 112 by not completely filling the sloped pocket insert 108 of the drill head, while still being securely and centrally seated in the pocket insert 108.

To aid in securing the self-centering cutting tool insert 104 to the drill head 102, a fastener 114 may be used. The fastener 114 may be a screw, a bolt, a rivet, or any other suitable fastening mechanism or means. In some examples the fastener 114 may be a square drive screw, Philips head, hex screw, or any other suitable screw drive shape.

The drill head 102 may also include a guide pad 116 which may be inserted into the drill head 102 to guide the position of the drill head 102 relative to a material it may be cutting. In some examples a guide pad 114 may also referred to as a wear pad. The guide pad 114 may be uniquely designed to aid the positioning of a particular drill head 102 or a particular self-centering cutting tool insert 104, and accordingly may be shaped and designed to correspond to these components dimensions to preserve the ability of a drill head system to create a low tolerance hole. In some examples, a guide pad 116 may only fit into a drill head 102 if corresponding to a guide pad pocket with a unique geometric design to exclude all other guide pad shapes. In this manner, a tamper resistant shape may be used to control and prevent the use of an incorrectly sized or low quality guide pad 116. The tamper resistant shape may be generated by a randomizer to randomly assign dimensions, within a suitable range, to the guide pad 116 and corresponding guide pad pocket. By this randomized generation of a geometric shape at the point of design, the use of third-party guide pads not specifically manufactured for use in this particular trepan design may be eliminated. The guide pad 116 used may be of any suitable components or grade including brazed components, single solid carbide components, and may vary in carbide grade or other grades of material. The guide pad 116 may vary in length to correspond to the length of the hole to be drilled. The longer length of a guide pad 116 provides additional control and precision as there is additional guidance surface area while inside the object to be drilled.

Regarding the corresponding guide pad pocket which may hold the guide pad 116, the pocket itself may be designed to hold the guide pad in place without the aid of any external holding or clamping type device or implement. The shape of the bottom of the guide pad pocket may be flat and parallel to the drill head 102, and may have an pad insertion area at a top face of the drill head 102. The guide pad pocket may be machined into the drill head 102 with a compounded angle. If a compound angle is include, a guide pad 116 inserted into the drill head 102 may be used to overcome the compound angle and position the guide pad 116 in place partially beyond the compound angle.

A chip throat 118 may be included on the drill head 102. In some examples the chip throat is shaped to allow the insertion of the self-centering cutting tool insert 104 into the insert pocket 108. The chip throat may be an opening in the drill head that gradually slopes or may be any other suitable opening to allow the insertion and fastening of the self-centering cutting tool insert 104. In some examples, the chip throat 118 is a break or opening in the drill head cutting surface to allow chips or shavings of the cut material to escape a cutting path. In some examples, the chip throat 118 is adjacent, on the drill head 102, to the self-centering cutting tool insert 104.

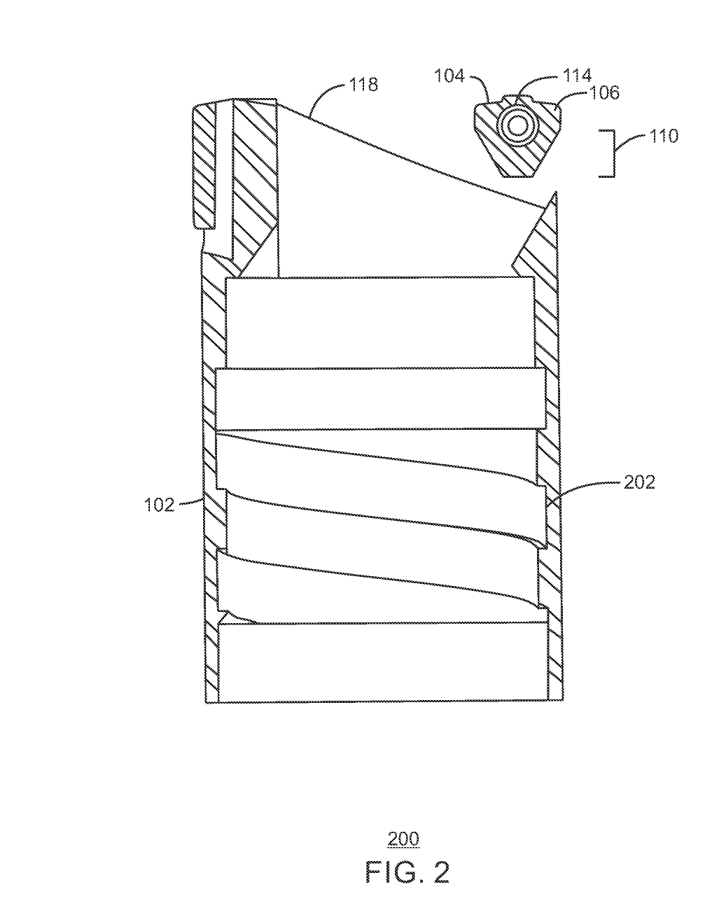

FIG. 2 is a diagram of a side view 200 of a drill head with a chip throat, according to an example. Like numbered items are as described with respect to FIG. 1. In FIG. 2, this side view of the drill head 102 may help to show one shape of the chip throat 118 that allows the insertion and fastening of the self-centering cutting tool insert 104 into the insert pocket 106. The example shown in FIG. 2 may also provide a view of a lower region 110 of the self-centering cutting tool insert 104 that tapers or slopes towards a similar point. In some examples, a slope of the lower region 110 may aid in positioning the self-centering cutting tool insert 104. In some cases a slope, taper, or bevel in the lower region 110 may correspond to a slope, taper, or bevel in an insert pocket 108 and the matching shapes of the insert pocket 108 and the lower region 110 may aid in centering the self-centering cutting tool insert 104.

A thread 202 may be included on the drill head 102 to secure the drill head 102 to the drill bar. In some examples the thread 202 may be measured in terms of the number of threads per inch exist across a stretch of space roughly perpendicular to the direction of the threads inside the drill head 102. In some examples, the thread 202 may have an equal thickness to the space between each thread 202 although other ratios are possible. In some examples, the thread 202 used in the drill head may be 1 thread per inch (tpi), 2 tpi, or any thickness in between these values. In some examples, the thread 202 used in the drill head may have a thickness or spacing where a threads per inch measurement are within the range of 0.9 tpi and 2.1 tpi. Thread counts within this range have been tested and experimental results suggest that within this range (0.9 tpi-2.1 tpi) is a good balance between ease of mounting and removal of the drill head while still preserving the proper grip and attachment strength. In some examples, threads 202 of a drill head 102 experience a certain torqueing force during a machining action and may bend, mushroom, or otherwise warp resulting in a locking of the drill head 202 to the drill bar. In some examples, the thread 202 tpi is proportionally linked to an estimated or maximum torque to be experienced by a drill head 202.

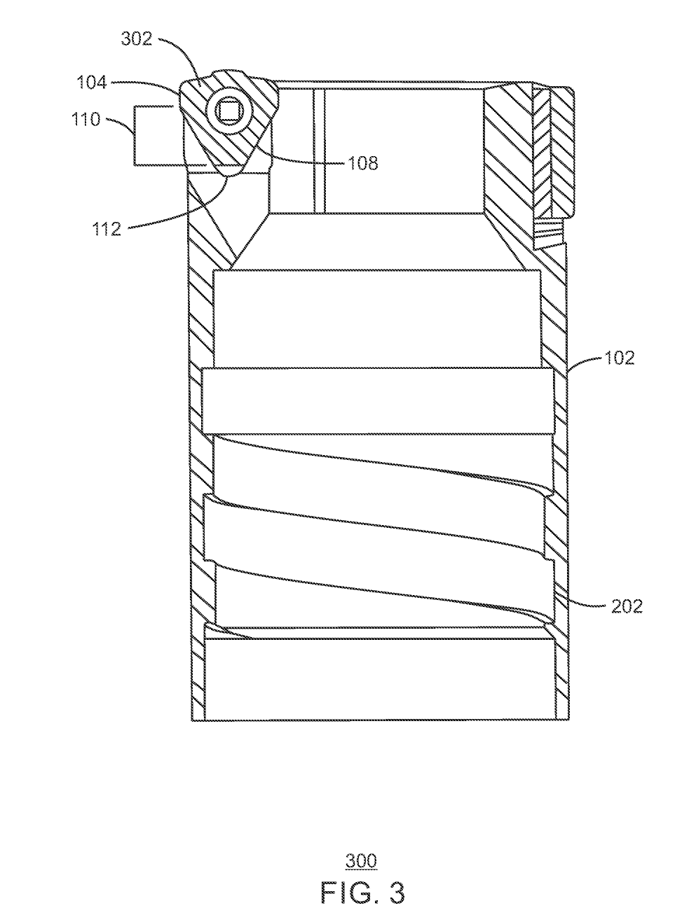

FIG. 3 is a diagram of a side view 300 of a drill head and self-centering cutting tool insert with screw threads, according to an example. Like numbered items are as described with respect to FIG. 1 and FIG. 2. In the side view 300 of FIG. 3, the empty space 112 of a pocket insert 108 is visible. In some examples, the self-centering insert 104 and the lower region 110 are shaped to match the shape of the pocket insert 108. The empty space 112 of the pocket insert 108 allows a self-centering cutting tool insert 104 to be inserted until snuggly contacting the insert pocket 108 of the drill head on at least two sides. In some examples, the lower region 110 is not the only shaped region to aid in centering the self-centering cutting tool insert 104. In some examples the self-centering cutting tool insert 104 includes a back side 302 that is opposite the cutting face 106 of the self-centering cutting tool insert 104. In the example seen in FIG. 3, a dimension of the back side is not shown but may receded or extrude up from the figure drawing example. The back side of the self-centering cutting tool insert 104 may be shaped to correspond to an insert pocket 108 to align the self-centering cutting tool insert 104 to a particular position for cutting. The shaping of a back side 302 and the corresponding insert pocket 108 may be sloped, beveled, or any other corresponding shapes to aid in centering the self-centering cutting tool insert 104.

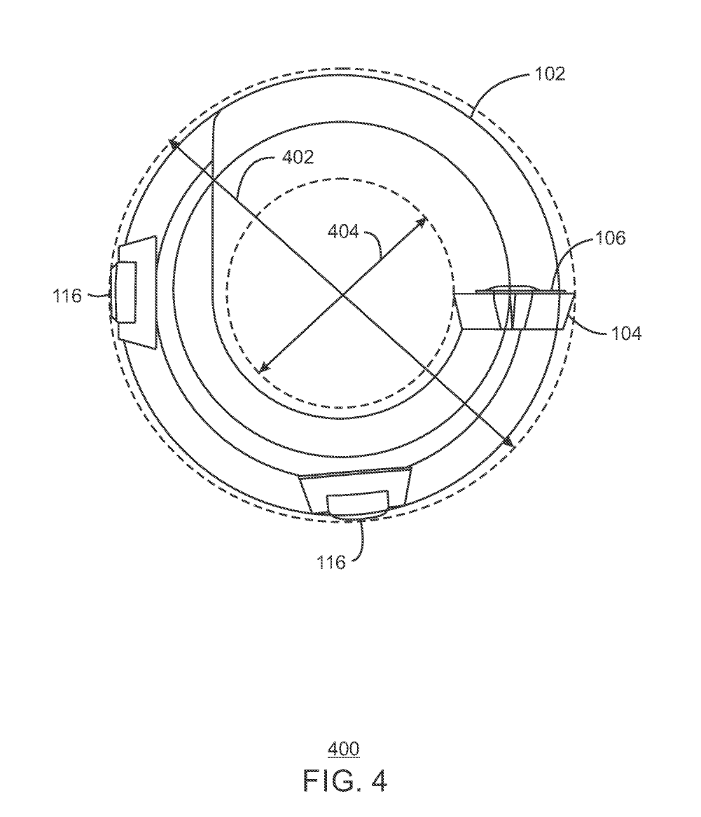

FIG. 4 is a top view 400 of a drill head and a self-centering cutting tool insert, according to an example. Like numbered items are as described with respect to FIG. 1. An outer diameter 402 and an inner diameter 404 are shown with the top view 400 of the drill head 102.

The outer diameter 402 may correspond to diameter of a circular hole cut by a drill head 102 with a self-centering cutting tool insert 102. In some examples the cutting face 106 may extend beyond the outer edge of the drill head 102. An extended part of a cutting face 106 may cut a circumference corresponding to the outer diameter 402.

The inner diameter 404 may correspond to diameter of a circular hole cut by a drill head 102 with a self-centering cutting tool insert 102. In some examples the cutting face 106 may extend beyond the inner edge of the drill head 102. An extended part of a cutting face 106 may cut a circumference corresponding to the inner diameter 404.

In some examples, the self-centering cutting tool insert may cut both the outer diameter 402 and the inner diameter 404 of a material simultaneously. The guide pads 116 may provide guidance to the drill head 102 relative to a material being drilled. In some examples, the location of the guide pads may be measured from a centerline of the drill head to ensure the self-centering cutting tool insert is cutting along the outer diameter 402 and inner diameter 404 at all times.

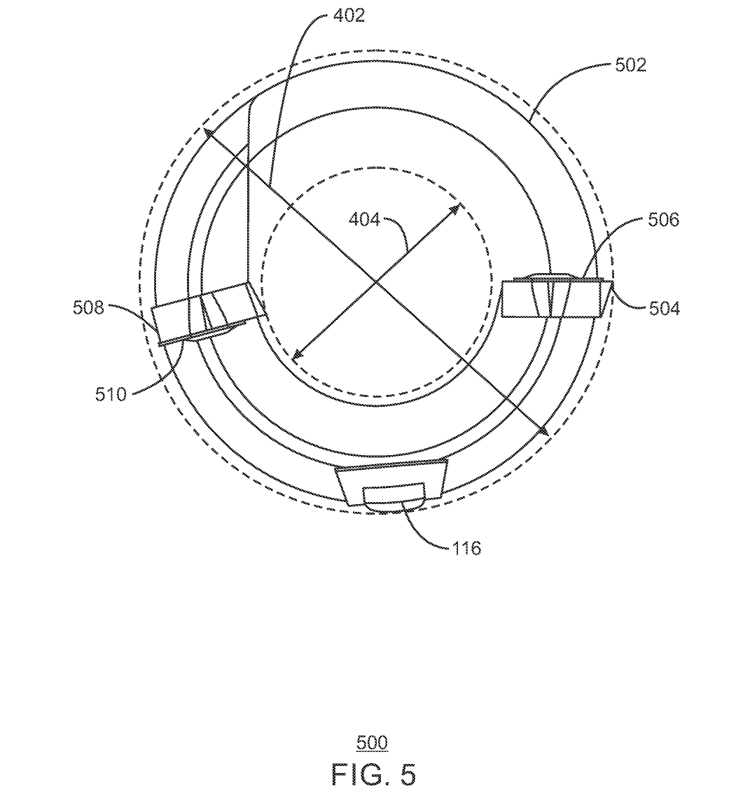

FIG. 5 is a diagram of a top view 500 of a drill head 502 with multiple self-centering cutting tool inserts, according to an example. Like numbered items are as described with respect to FIG. 1 and FIG. 4. The drill head 502 may include a first self-centering cutting tool insert 504 to cut along an outer circumference formed by an outer diameter 402 with a first cutting face 504. In some examples, the drill head 502 may include a second self-centering cutting tool insert 508 to cut along an inner circumference formed by an inner diameter 404 with a first cutting face 510.

In an examples, when the drill head 502 is attached to a drill bar, the circumference of an inner diameter of the drill bar may be smaller than an inner diameter 404 of the drill head. An inner core of material that is passing through the inner diameter 404 of a drill head 502 may become stuck if it is too large to pass through the inner diameter of the drill bar. In some examples, the second self-centering cutting tool insert 508 may be adjusted, seated, or centered to cut a circumference corresponding to an inner diameter 404 that is equal to the inner diameter of a drill bar. Likewise, in some examples, the drill head 502 may be designed with an increased thickness to allow a second self-centering cutting tool insert to cut the inner diameter 404 to allow a core of a material to pass through both the inner diameter 404 and the inner diameter of the drill bar to which the drill head 502 is attached.

In some examples, the second self-centering cutting tool insert 508 may correspond to a second chip throat on the drill head 502. In some examples the second chip throat is shaped to allow the insertion of the second self-centering cutting tool insert 508 into a second insert pocket. The second chip throat may be an opening in the drill head that gradually slopes or may be any other suitable opening to allow the insertion and fastening of the second self-centering cutting tool insert 508. In some examples, the second chip throat is a break or opening in the drill head cutting surface to allow chips or shavings of cut material to escape a cutting path. In some examples, the second chip throat is adjacent, on the drill head 502, to the second self-centering cutting tool insert 508.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

### EXAMPLES

### Example 1

In one example, a drill head system may include a self-centering cutting tool insert including a cutting face, a drill head to cut a trepan hole including an insert pocket to hold the self-centering cutting tool insert to the drill head without a cartridge disposed between the self-centering cutting tool insert and the drill head. In an example, the drill head system may also include a fastener securing the self-centering cutting tool insert into the insert pocket of the drill head through the cutting face. A back side of the self-centering cutting tool insert may be opposite the cutting face and the insert pocket may be sloped to receive the back side of the self-centering cutting tool insert and guide the self-centering cutting tool insert to a centered position. In an example, the self-centered cutting tool insert may include a lower region, and the insert pocket may be sloped to receive the lower region of the self-centering cutting tool insert and guide the self-centering cutting tool insert to a centered position. In an example, the self-centering cutting tool insert may be shaped to correspond to the insert pocket, and the insert pocket may be machined to automatically guide the self-centering cutting tool insert to a centered position. The fastener may be a square drive screw. In an example, a chip throat may be included in the drill head and shaped to allow insertion and fastening of the self-centering cutting tool insert to the drill head. In an example, the self-centering cutting tool insert may be fastened to the drill head to cut both an outer diameter around the drill head and an inner diameter within the drill head. In an example, the self-centering cutting tool insert may be fastened to the drill head to cut an outer diameter around the drill head, the drill head system including a second chip throat shaped to allow insertion and fastening of the a second self-centering cutting tool insert to the drill head to cut an inner diameter within the drill head. In examples, with a second self-centering cutting tool insert, the second self-centering cutting tool insert may be adjustably fastened to the drill head such that the position of the second self-centering cutting tool insert may correspond to a drill bar inner diameter. In an example, a drill head system may include a number of drill head threads per inch, where the threads per inch may be within the range of 0.9 threads per inch to 2.1 threads per inch. In an example, a drill head may include a guide pad pocket located from a centerline of the drill head, where the guide pad pocket holds a guide pad to jut out from the drill head equal to the amount the self-centering cutting tool insert extends past an outer edge of the drill head.

### Example 2

In an example, an apparatus for insertion into a drill head may include a self-centering cutting tool insert to fit within an insert pocket of a drill head without a cartridge disposed between the self-centering cutting tool insert and the drill head. The cutting tool insert may include a cutting face and the apparatus may include a fastener to secure the cutting tool insert into the insert pocket of the drill head through the cutting face of the self-centering cutting tool insert. In an example, a back side of the self-centering cutting tool insert may be opposite the cutting face, and the insert pocket may be sloped to receive the back side of the self-centering cutting tool insert and guide the self-centering cutting tool insert to a centered position. In an example, the self-centering cutting tool insert may include a lower region, and wherein the insert pocket may be sloped to receive the lower region of the self-centering cutting tool insert and guide the self-centering cutting tool insert to a centered position. In an example, the self-centering cutting tool insert may be shaped to correspond to the insert pocket, and the insert pocket may be machined to guide the self-centering cutting tool insert to a centered position. In an example, the fastener may be a square drive screw.

### Example 3

In an example, a drill head to cut a trepan hole may include a generally cylindrical structure having an insert pocket to hold a self-centering cutting tool insert to the drill head without a cartridge disposed between the self-centering cutting tool insert and the drill head. The generally cylindrical structure may further include a guide pad pocket to hold a guide pad insert, the guide pad pocket to be shaped with a tamper resistant shape. In an example, the tamper resistant shape of the guide pad pocket may corresponds to a shape of the guide pad insert. The generally cylindrical structure may include a second guide pad pocket shaped with a second tamper resistant shape. In an example, the generally cylindrical structure includes a chip throat shaped to allow insertion and fastening of a self-centering cutting tool insert to the generally cylindrical structure.

What is claimed is:

1. A drill head system, comprising:
a self-centering cutting tool insert comprising a cutting face;
a drill head to cut a trepan hole, the drill head comprising an insert pocket to hold the self-centering cutting tool insert to the drill head without a cartridge disposed between the self-centering cutting tool insert and the drill head; and
a fastener securing the self-centering cutting tool insert into the insert pocket of the drill head through the cutting face.

2. The drill head system of claim 1, wherein a back side of the self-centering cutting tool insert is opposite the cutting face, and wherein the insert pocket is sloped to receive the back side of the self-centering cutting tool insert and guide the self-centering cutting tool insert to a centered position.

3. The drill head system of claim 1, wherein the self-centered cutting tool insert includes a lower region, and wherein the insert pocket is sloped to receive the lower region of the self-centering cutting tool insert and guide the self-centering cutting tool insert to a centered position.

4. The drill head system of claim 1, wherein the self-centering cutting tool insert is shaped to correspond to the insert pocket, and the insert pocket is machined to automatically guide the self-centering cutting tool insert to a centered position.

5. The drill head system of claim 1, wherein the fastener is a square drive screw.

6. The drill head system of claim 1, comprising a chip throat shaped to allow insertion and fastening of the self-centering cutting tool insert to the drill head.

7. The drill head system of claim 1, wherein the self-centering cutting tool insert is fastened to the drill head to cut both an outer diameter around the drill head and an inner diameter within the drill head.

8. The drill head system of claim 1, wherein the self-centering cutting tool insert is fastened to the drill head to cut an outer diameter around the drill head, the drill head system comprising a second chip throat shaped to allow insertion and fastening of the a second self-centering cutting tool insert to the drill head to cut an inner diameter within the drill head.

9. The drill head system of claim 8, wherein the second self-centering cutting tool insert is to be adjustably fastened to the drill head such that the position of the second self-centering cutting tool insert is to correspond to a drill bar inner diameter.

10. The drill head system of claim 1, comprising a number of drill head threads per inch, where the threads per inch is within the range of 0.9 threads per inch to 2.1 threads per inch.

11. The drill head system of claim 1, wherein a drill head includes a guide pad pocket located from a centerline of the drill head, where the guide pad pocket holds a guide pad to jut out from the drill head equal to the amount the self-centering cutting tool insert extends past an outer edge of the drill head.

12. An apparatus for insertion into a drill head, comprising:
a self-centering cutting tool insert to fit within an insert pocket of a drill head without a cartridge disposed between the self-centering cutting tool insert and the drill head, the cutting tool insert comprising a cutting face; and
a fastener that secures the cutting tool insert into the insert pocket of the drill head through the cutting face of the self-centering cutting tool insert.

13. The drill head system of claim 12, wherein a back side of the self-centering cutting tool insert is opposite the cutting face, and wherein the insert pocket is sloped to receive the back side of the self-centering cutting tool insert and guide the self-centering cutting tool insert to a centered position.

14. The drill head system of claim 12, wherein the self-centering cutting tool insert includes a lower region, and wherein the insert pocket is sloped to receive the lower region of the self-centering cutting tool insert and guide the self-centering cutting tool insert to a centered position.

15. The drill head system of claim 12, wherein the self-centering cutting tool insert is shaped to correspond to the insert pocket, and the insert pocket is machined to guide the self-centering cutting tool insert to a centered position.

16. The drill head system of claim 12, wherein the fastener is a square drive screw.

17. A drill head to cut a trepan hole, comprising a generally cylindrical structure having an insert pocket to hold a self-centering cutting tool insert to the drill head without a cartridge disposed between the self-centering cutting tool insert and the drill head, the generally cylindrical structure further having a guide pad pocket to hold a guide pad insert, the guide pad pocket to be shaped with a tamper resistant shape.

18. The drill head to cut a trepan hole of claim 17, wherein the tamper resistant shape of the guide pad pocket corresponds to a shape of the guide pad insert.

19. The drill head to cut a trepan hole of claim 17, wherein the generally cylindrical structure includes a second guide pad pocket shaped with a second tamper resistant shape.

20. The drill head to cut a trepan hole of claim 17, wherein the generally cylindrical structure includes a chip throat shaped to allow insertion and fastening of a self-centering cutting tool insert to the generally cylindrical structure.
